(19) United States
(12) Patent Application Publication
(10) Pub. No.: US 2019/0119045 A1
(43) Pub. Date: Apr. 25, 2019

(54) RETAIL-READY PACKAGING OF POUCHED PRODUCT

(71) Applicant: KHS GmbH, Dortmund (DE)

(72) Inventors: Luke L. Vazul, Clearwater, FL (US); Michael Sammons, Parrish, FL (US); Sean Patrick Wells, Mukwonago, WI (US); Kristi Nordlund, Sarasota, FL (US); Roger Calabrese, Bradenton, FL (US)

(21) Appl. No.: 16/223,395

(22) Filed: Dec. 18, 2018

Related U.S. Application Data
(63) Continuation-in-part of application No. 14/018,546, filed on Sep. 5, 2013.

(51) Int. Cl. B65G 17/12; B65G 17/00; B65G 17/34; B65G 47/56; B65B 5/08; B65B 35/16

(52) U.S. Cl. CPC B65G 17/123; B65G 17/002; B65G 17/34; B65G 2207/14; B65B 5/08; B65B 35/16; B65G 47/56

(57) ABSTRACT

A pouch-placement machine includes an elevator assembly that receives pouches from one conveyor, lifts them up for presentation to robot arms. The robot arms pick pouches from the elevator assembly and place them into cartons that are on a second conveyor.

### RELATED APPLICATIONS

This application is a continuation-in-part of U.S. application Ser. No. 14/018,546, filed on Sep. 5, 2013, now pending.

### FIELD OF DISCLOSURE

This disclosure relates to retail-ready packaging, and in particular, to filling retail-ready packages with pouched products.

### BACKGROUND

In the early days of retailing, a retailer would receive a large box of goods from a manufacturer. Inside the box were retail units of some product. The retailer would then perform an operation called “restocking the shelves.” This would involve taking the individual retail units from the box and placing them neatly on the shelves to create an attractive display. The box, however, would remain in a back room, invisible to retail customers.

One difficulty with this system is an obvious one. It is tedious to restock the shelves one retail unit at a time.

Another, more pernicious, difficulty arises from the fact that the mere presence of a retail unit on the shelf, particularly one with an eye-catching design, calls attention to itself and stimulates sales. As more people buy, the number of units decreases, and hence the commercial impression of the retail units decreases. This creates a negative feedback loop in which as the rate of sales of retail units increases, the commercial impression created by the aggregate of retail units decreases.

In modern retailing, a retailer again receives a large box of goods from a manufacturer. However, inside the box are several smaller cartons, often called “retail-ready packages.” These cartons typically have an attractive design printed on them, and a perforation that can be torn away to reveal the individual retail units available for purchase. To re-stock shelves, the retailer simply tears the carton carefully at the perforation and places the entire carton on the shelf. This simplifies re-stocking considerably, since it is no longer necessary to carefully arrange the retail units on a shelf. In addition, even if all retail units have been sold, the carton remains and continues to create a commercial impression.

A difficulty in retail-ready packaging is that the retail units must be placed in the carton in a neat and attractive way.

Certain kinds of retail units are rigid and have a well-defined size and shape. Examples are boxes, cans, bottles, shrink-wrapped items, such as diapers or paper towels, cartons, such as milk cartons, and plastic containers, such as those used for yogurt. For these retail units, it is known to use a robot to pick individual retail units off a conveyor and place them in a retail-ready carton.

However, there is one common type of retail unit that lacks these properties: the pouch. Pouches, such as those used to package chips and nuts, are deformable, and tend not to have a uniform shape. This causes great difficulty for robots. As a result, it is not uncommon to fill retail-ready cartons by hand.

### SUMMARY

In one aspect, the invention features an apparatus that includes an elevator assembly that receives pouches from a first conveyor and elevates them for presentation to plural robot arms that proceed to pick pouches presented to them by the elevator assembly and to place them in a carton that is transported on a second conveyor.

In some embodiments, the second robot arm places a second pouch adjacent to a first pouch that was placed in the carton by the first robot arm in such a way that the second pouch lies closer to the elevator assembly than the first pouch. As a result, a row of pouches is built up in the carton starting with the pouch furthest away from the elevator assembly and ending with the pouch closest to the elevator assembly.

In other embodiments, the second conveyor is tilted such that the pouches in the cartons are urged to topple in a direction away from the elevator assembly. The extent of the tilt depends on the pouch. Embodiments include those in which the extent of the tilt is adjustable and those in which the extent of the tilt is half of a right angle or thereabouts.

In yet other embodiments, elevator assembly comprises paddles for receiving pouches provided by the first conveyor, and wherein the first and second robot arms pick pouches from alternate paddles. Among these are embodiments in which the paddles comprise a 2n^{th} paddle and a (2n+1)th paddle with no paddles therebetween, wherein n is a non-negative integer, wherein the first robot arm is configured to retrieve a first pouch from the 2n^{th} paddle and place the first pouch in a retail-ready carton on the second conveyor, and wherein the second robot arm is configured to retrieve a second pouch from the (2n+1)^{th} paddle and place the pouch the second pouch in a retail-ready carton on the second conveyor.

Also among the embodiments are those that have more than two robot arms. In such cases, all of the robot arms pick pouches from the elevator assembly at different times and place the pouches into the carton at different times.

Further embodiments include those in which the first and second conveyors run in different directions, those in the first and second conveyors are perpendicular to each other, those in which the second conveyor lies above the first conveyor, and those in which the first and second robot arms are above the first conveyor.

The term “retail-ready package” is not intended to mean a package that is ready to be sold at retail. After all, any package can technically be sold at retail if a willing buyer can be found. The term “retail-ready package” is a term of art in the packaging industry. The meaning of “retail-ready package” can best be derived by observing instances of what the ordinary artisan would regard as a “retail-ready package” and extracting from those observations the features that all such retail-ready packages have in common. This is not an unusual way to learn the meaning of a term. Indeed, this is exactly how words were learned before dictionaries were invented.

Examples of retail-ready packages can be found in many supermarkets and are particularly common in the sale of candies and nuts. These packages are typically cartons that are torn open at a perforation and placed on the shelf. Tearing the carton open reveals individual items, commonly pouches or bars, that can be purchased. Typically, the package will have a design that in some sense echoes or mimics the design of the individual items within it. These differ from cartons that contain the product but are typically intended for shipping rather than display.

It is possible that one might interpret “retail-ready” package as meaning any package that can be sold at retail. However, one who did so would be: construing the term in a manner that is not in light of the specification and displaying ignorance of how the term is used in the art.

These and other features of the invention will be apparent from the following detailed description and the accompanying figures, in which:

### BRIEF DESCRIPTION OF THE FIGURES

FIG. 1 shows a pouch packaging system;

FIG. 2 is a view of the pouch placer from the pouch packaging system of FIG. 1 as seen from the point of view of an incoming pouch;

FIG. 3 shows a detailed view of the elevator towers from the pouch placer of FIG. 2;

FIG. 4 shows the use of a backstop in one of the elevator towers of FIG. 2;

FIG. 5 shows a backstop like that in FIG. 4 but tilted to push a pouch towards a robot arm;

FIG. 6 shows a leaning version of the elevator tower of FIG. 3;

FIG. 7 shows an elevator tower from a pouch placer having a single-tower elevator system;

FIG. 8 shows an effector for a robot arm of the pouch placer of FIG. 2;

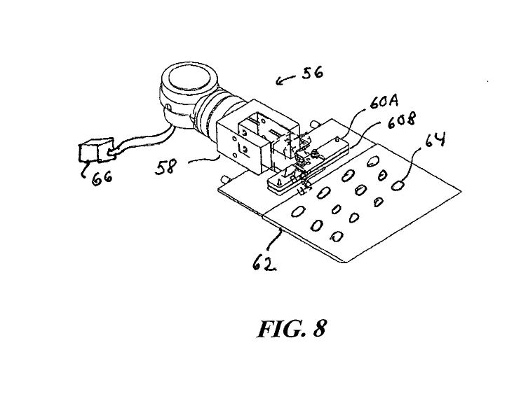

FIG. 9 shows a dual-robot embodiment;

FIG. 10 shows the dual-robot embodiment of FIG. 9 from the side; and

FIG. 11 is an isometric view of the dual-robot embodiment of FIG. 9.

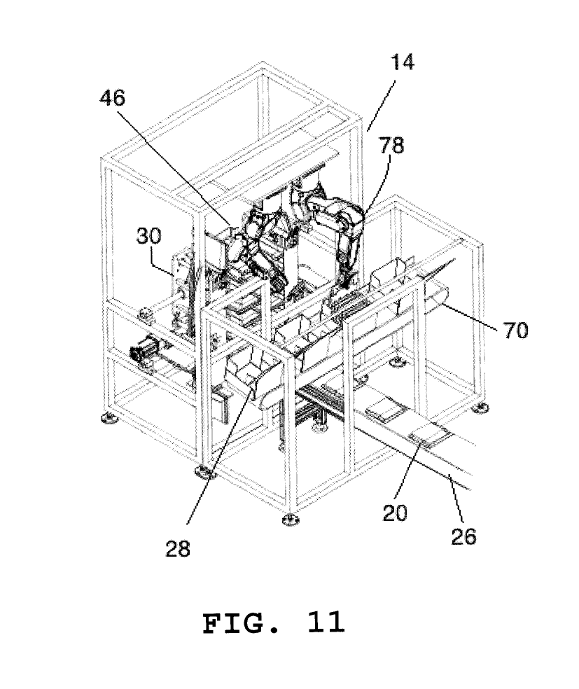

### DETAILED DESCRIPTION

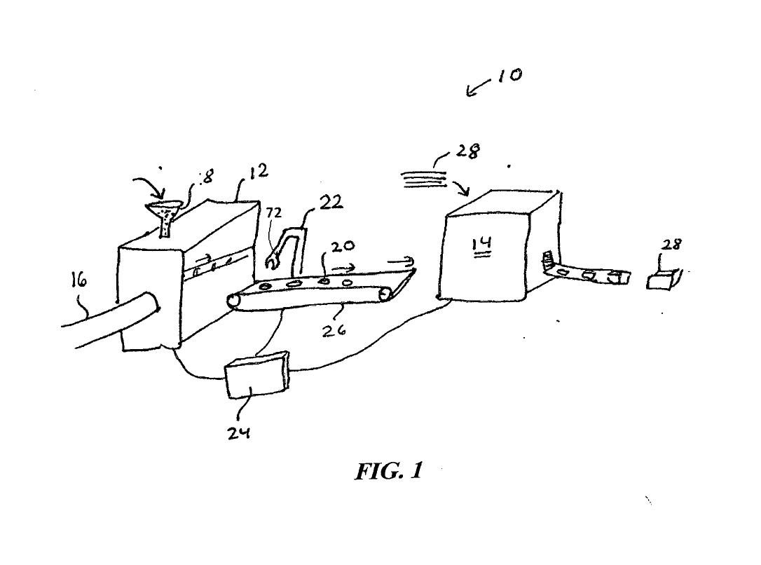

A pouch packaging system 10, shown in FIG. 1, includes a pouch filler 12 and a pouch placer 14.

The pouch filler 12 receives a supply of webbing 16 and product 18. Its function is to form the webbing 16 into pouches 20, to place a measure of product 18 into each pouch 20, seal the pouch 20, which is now a filled pouch, and to present each such filled pouch 20 to a first robot arm 22 controlled by a control system 24. The first robot arm 22 places filled pouches 20 on a first conveyor belt 26, which then conveys the filled pouches 20 to the pouch placer 14.

The pouch placer 14 receives, as inputs, the filled pouches 20 from the pouch filler 12, and a supply of retail-ready cartons 28. The function of the pouch placer 14 is to erect these retail-ready cartons 28, receive pouches 20 from the pouch filler 12, and place these pouches 20 into the erected retail-ready cartons 28.

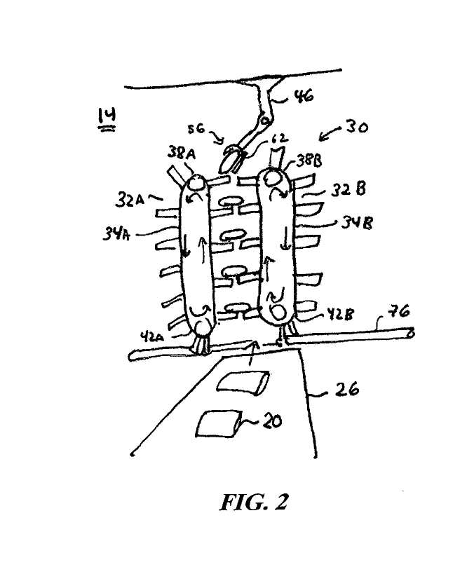

Referring now to FIG. 2, the pouch placer 14 features an elevator assembly 30. Embodiments of this elevator assembly 30 include those with one tower 32A and those with two towers 32A, 32B. In the particular embodiment shown in FIG. 2, the elevator assembly 30 features first and second twin elevator towers 32A, 32B.

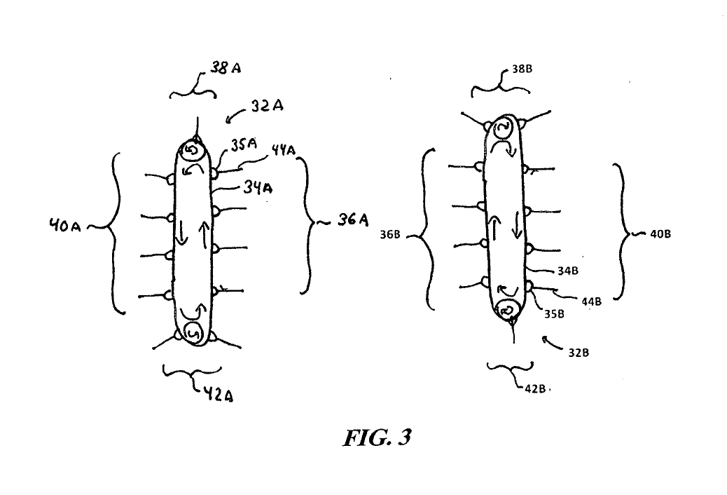

Referring now to FIGS. 3A and 3B, the first tower 32A features a vertically oriented conveyor chain 34A that travels up an inner vertical section 36A of the first tower 32A, loops around an upper turnaround section 38A of the first tower 32A, travels down an outer vertical section 40A of the first tower 32A, and loops around a lower turnaround section 42A of the first tower 32A to begin its journey back up the inner vertical section 36A.

The second tower 32B is a mirror image of the first tower 32A in both structure and operation. Like the first tower 32A, the second tower 32B has a vertically oriented conveyor chain 34B that travels up an inner vertical section 36B of the second tower 32B, loops around an upper turnaround section 38B of the second tower 32B, travels down an outer vertical section 40B of the second tower 32B, and loops around a lower turnaround section 42B of the second tower 32B to begin its journey back up the inner vertical section 36B.

The second tower 32B is oriented such that the inner vertical section 36A of the first tower 32A faces an inner vertical section 36B of the second tower 32B.

Each conveyor chain 34A, 34B has, mounted thereon, regularly spaced clips 35A, 35B. Each clip 35A, 35B engages a paddle 44A, 44B that extends outwardly from the conveyor chain 34A, 34B in a direction perpendicular to the conveyor chain 34A, 34B. As the conveyor chain 34A, 34B moves, so too does each paddle 44A, 44B.

Movement of the paddles 44A of the first tower 32A and the paddles 44B second tower 32B is synchronized in both frequency and phase such that as a first paddle 44A from the first tower 32A traverses the inner vertical section 36A of the first tower 32A, a corresponding second paddle 44B also traverses the inner vertical section 36B of the second tower 32B at the same time. The first tower 32A and second tower 32B are separated such that a small gap exists between the first paddle 44A and the second paddle 44B.

The first paddle 44A and the second paddle 44B thus come together at a bottom end of their respective inner vertical sections 36A, 36B and cooperate to form a support surface for lifting a pouch 20 upwards, between the first and second towers 32A, 32B, for presentation to a second robot arm 46. Once the second robot arm 46 picks up the pouch 20, the first and second paddles 44A, 44B begin to move apart as each one traverses the upper turnaround section 38A, 38B of its corresponding tower 32A, 32B.

Referring back to FIG. 2, the first conveyor belt 26 is oriented to aim pouches 20 directly into the space between the first and second towers 32A, 32B. The movement of the paddles 44A, 44B is synchronized with that of the first conveyor belt 26 such that at the precise moment a pouch 20 reaches the space between the first and second towers 32A, 32B, the first and second paddles 44A, 44B are just beginning their upward journey along the inner vertical sections 36A, 36B of their respective towers 32A, 32B, where they are in the correct location for receiving the pouch 20.

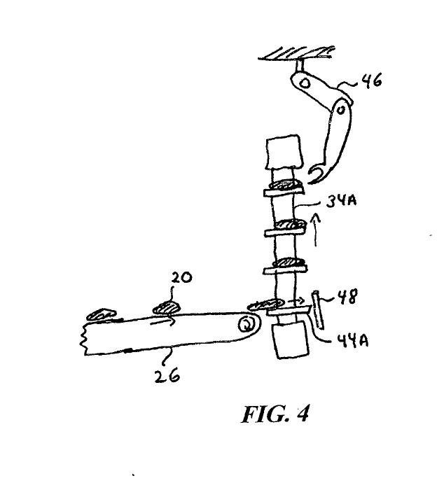

In general, it is difficult to impart exactly the correct velocity to a pouch 20 so as to have it come to rest at a desired position on the first and second paddles 44A, 44B. To avoid having to do so, a backstop 48 is placed behind the paddles 44A, 44B, as shown in FIG. 4. This backstop 48 prevents a pouch 20 from overshooting the first and second paddles 44A, 44B. The first conveyor belt 26 thus imparts sufficient velocity to the pouch 20 so that it can at least reach the backstop 48, and thus be positioned correctly. A suitable backstop 48 is implemented as one or more vertical rods or bars with the number being selected at least in part based on the size of the pouch 20.

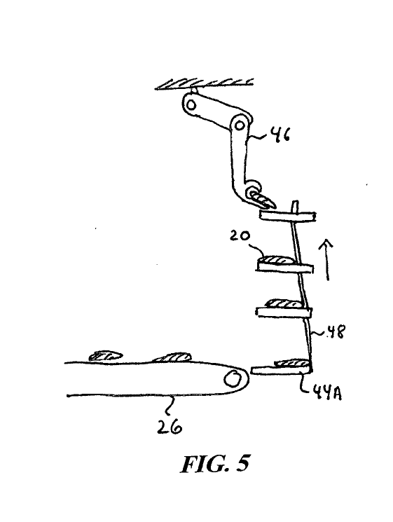

In some embodiments, the backstop 48 may not be vertical relative to the paddles 44A, 44B as the paddles 44A, 44B travel up the inner vertical sections 36A, 36B of their respective towers. Instead, the backstop 48 may be oriented to lean toward the first conveyor belt 26 and to extend upward at least part way along the inner vertical section 36A, 36B, as shown in FIG. 5. In these embodiments, the backstop 48 catches the pouch 20 when the first and second paddles 44A, 44B are at the bottom of the vertical inner section. Then, as the conveyor chains 34A, 34B lift the first and second paddles 44A, 44B up the inner vertical section 36A, 36B, the backstop 48 pushes the pouch 20 slightly forward, thus adjusting its position to prepare it for presentation to the second robot arm 46.

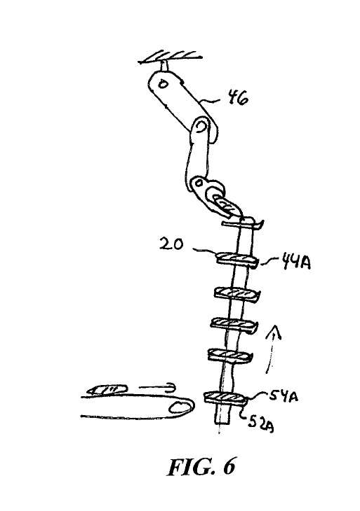

In another embodiment, shown in FIG. 6, the first and second towers 32A, 32B themselves are tilted to lean away from the first conveyor belt 26. As a result, once a pouch 20 lands on the first and second paddles 44A, 44B, gravity urges the pouch 20 toward a side 52A, 52B of the paddle 44A, 44B furthest from the first conveyor belt 26. In this embodiment, it is preferable to have a lip 54A, 54B at the end of the paddle 44A, 44B that is furthest from the first conveyor belt 26 to prevent the pouch 20 from falling off the paddle 44A, 44B altogether.

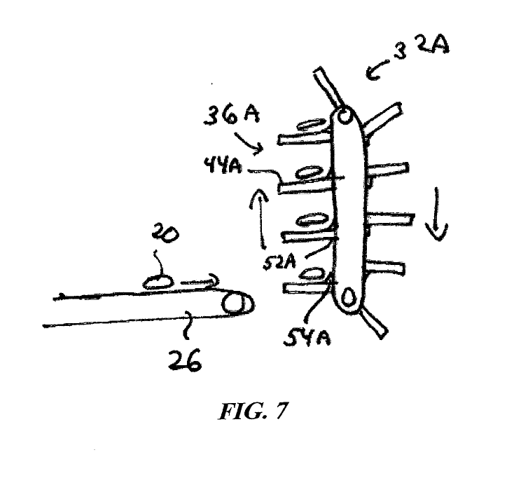

Another embodiment, shown in FIG. 7, has only a single tower 32A. In this embodiment, the inner vertical section 36A of the tower 32A faces the first conveyor belt 26. In this embodiment, it is again preferable for the side 52A of a paddle 44A away from the first conveyor belt 26 to have a lip 54A to function as a backstop.

As was the case in the preceding embodiment, which had twin towers 32A, 32B, the sole tower 32A in the single-tower embodiment can also be made to lean away from the first conveyor belt 26, thus enabling gravity to urge the pouch 20 to remain in the paddle 44A.

Referring to FIG. 6, a robot arm effector 56 includes a clamp 58 having first and second grippers 60A, 60B that cooperate to engage an edge of the pouch 20. For small pouches 20, this arrangement is sufficient. However, when a pouch 20 clamped at an edge thereof is picked up, the free portion of the pouch 20 tends to dangle like a pendulum. This makes it difficult for the second robot arm 46 to control the pouch 20 while moving it and attempting to place it in a retail-ready carton 28.

To avoid this difficulty, it may be useful for a lower one of the two grippers 60B to have a spatula 62 extending therefrom. When a clamp having such a spatula lifts the pouch 20 off a paddle, the spatula 62 supports the pouch 20 and assists in guiding the pouch 20 to its proper position in the retail-ready carton 28.

In another embodiment, the spatula 62 includes holes 64 connected to a vacuum source 66. In this embodiment, as the second robot arm 46 lifts the pouch 20 off the paddle 44A, the vacuum source 66 turns on and causes a vacuum that secures the pouch 20 to the spatula 62. Then, when the second robot arm 46 places the pouch 20 in its proper place in the retail-ready carton 28, the vacuum source 66 either turns off or reverses itself to gently blow the pouch 20 off of the spatula 62.

In some cases, a pouch 20 is incorrectly filled, for example by having too much or too little product 18 placed therein. These pouches 20 are preferably rejected. To address this, it is useful to provide one of the first and second robot arms 22, 46 with an accelerometer 72. Since the overall force applied to the robot arm 22, 46 is known, measurements of the arm's acceleration provide a basis for inferring the pouch's weight. Based on data from this accelerometer 72, the control system 24 determines whether the pouch 20 should be placed on the first conveyor belt 26 or rejected.

An advantage of the apparatus described herein is the ease with the elevator assembly 30 and the second robot arm 46 can be adapted to accommodate different pouches 20.

The first and second towers 32A, 32B are mounted to and horizontally movable along a horizontal guide 76. The towers 32A, 32B are spaced apart by a distance that corresponds to a linear dimension of the pouch 20. Since the pouch placer 14 is intended to work with different size pouches 20, the variable spacing between the towers 32A, 32B provides adjustment for different size pouches 20.

In addition, it is a simple matter to detach the paddles 44A, 44B from the clips 35A, 35B on the conveyor chain 34A, 34B and to attach different paddles having different dimensions, which can then accommodate different size pouches 20. Finally, the backstop 48 can be adjusted, for example by changing the number of vertical rods or bars 50A, 50B and their positions in a manner that is optimized for the dimensions of a particular pouch 20.

Customizability of the second robot arm 46 arises from its interchangeable effector 56. Effectors 56 can vary in the dimensions of the grippers 60A, 60B, in the texture of the gripping surface of the grippers 60A, 60B, in the presence or absence of a spatula 62, and in the presence or absence of a vacuum source 66, and in the size and configuration of the holes 64.

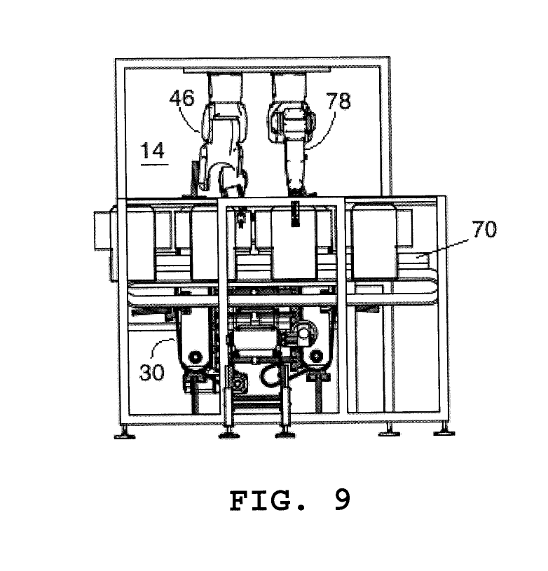

In another embodiment, shown in FIG. 9, the pouch placer 14 includes the second robot arm 46 and a third robot arm 78. The second and third robot arms 46, 78 are operated out of phase such that when the second robot arm 46 is picking up a pouch 20 from a 2n^{th} paddle on the elevator assembly 30 the third robot arm is placing, into a carton 28 traveling on a second conveyor belt 70, a pouch 20 that it picked earlier from a (2n+1)^{th} paddle on the elevator assembly, wherein n is a non-negative integer and wherein the 2n^{th} paddle and the (2n+1)^{th} paddle are successive paddles such that there are no paddles between them.

The second conveyor belt 70 runs perpendicular to and above the first conveyor belt 26 within easy reach of the second and third robot arms 46, 78.

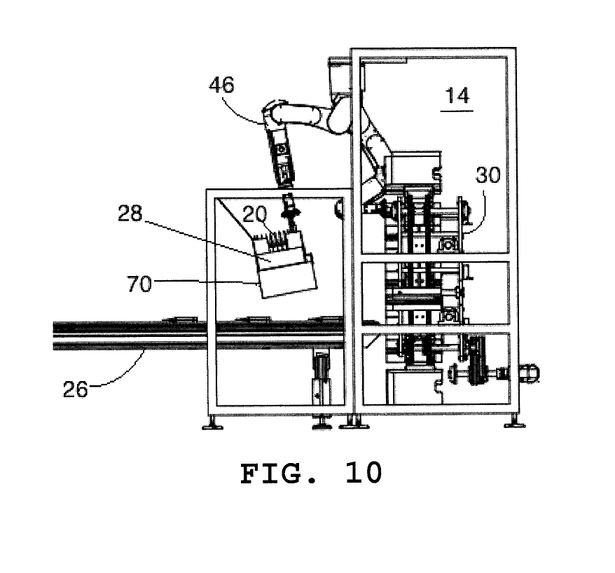

FIG. 10 shows the second robot arm 46 after having just placed the last pouch 20 in a carton 28. As suggested by FIG. 10, the second and third robot arms 46, 78 begin by placing those pouch 20 that are furthest from the elevator assembly 30. The last pouch 20 to be placed in the carton 28 is thus placed closest to the elevator assembly 30.

By its nature, a pouch 20 tends to be unstable and likely to topple over. This poses a difficulty when placing the pouches 20 in the carton 28. To ameliorate this difficulty, the second conveyor belt 70 is tilted away from the second and third robot arms 46, 78 such that gravity will cause a pouch that has been placed into the carton 28 to tip over backwards, away from the elevator assembly 30. This reduces the tendency of a pouch to fall over in a direction that causes it to occupy space intended for further pouches 20 that have yet to be placed into the carton 28.

The angle by which the second conveyor belt 70 tilts depends on how unstable the pouches are. Pouches that are relatively wide will form a stable base and be less likely to tip over. However, many pouches are narrow at each end and bulge out only in their middle sections. These pouches have what amounts to a linear base and cannot readily stand. A suitable is that shown, which is approximately half of a right-angle. However, to accommodate different pouches, it is useful for the second conveyor belt 70 to be adjustable so that it can be made to tilt at different angles.

The choice of two robot arms arises because it is easier to control two robot arms so that they do not collide during operation. However, it is also possible to have more than two robot arms that all operate to pick pouches and place them in a carton at different times, thus increasing throughput.

Having described the invention, and a preferred embodiment thereof, what we claim as new, and secured by letters patent, is:

1. An apparatus comprising
an elevator assembly, a first conveyor, a second conveyor, a first robot arm, and a second robot arm,
wherein said elevator assembly receives pouches from said first conveyor and elevates said pouches for presentation to said first and second robot arms,
wherein said first and second robot arms are configured to pick pouches from said elevator assembly and place them in a carton that is transported on said second conveyor.

2. The apparatus of claim 1, wherein said second robot arm is configured to place said second pouch adjacent to said first pouch such that said second pouch lies closer to said elevator assembly than said first pouch.

3. The apparatus of claim 1, wherein said second conveyor is tilted such that said first and second pouch are urged to topple in a direction away from said elevator assembly.

4. The apparatus of claim 3, wherein said conveyor is tilted by half of a right angle.

5. The apparatus of claim 1, wherein said elevator assembly comprises paddles for receiving pouches provided by said first conveyor, and wherein said first and second robot arms pick pouches from alternate paddles.

6. The apparatus of claim 5, wherein said paddles comprise a 2n^{th} paddle and a (2n+1)^{th} paddle with no paddles therebetween, wherein n is a non-negative integer, wherein said first robot arm is configured to retrieve a first pouch from said 2n^{th} paddle and place said first pouch in a retail-ready carton on said second conveyor, and wherein said second robot arm is configured to retrieve a second pouch from said (2n+1)^{th} paddle and place said pouch said second pouch in a retail-ready carton on said second conveyor.

7. The apparatus of claim 1, further comprising additional robot arms, wherein all of said robot arms pick pouches from said elevator assembly at different times and place said pouches into said carton at different times.

8. The apparatus of claim 1, wherein said second conveyor belt is adjustable to tilt at different angles.

9. The apparatus of claim 1, wherein said first and second conveyors run in different directions.

10. The apparatus of claim 1, wherein said first and second conveyors are perpendicular to each other.

11. The apparatus of claim 1, wherein said second conveyor lies above said first conveyor.

12. The apparatus of claim 1, wherein said first and second robot arms are above said first conveyor.
